(19) United States
(12) Patent Application Publication
(10) Pub. No.: US 2025/0092923 A1
(43) Pub. Date: Mar. 20, 2025

(54) Modular Multi-Phase Actuator for Reconfigurable Mechanical Power Amplification

(71) Applicant: Queen's University at Kingston, Kingston (CA)

(72) Inventors: Matthew Robertson, Kingston (CA); Bastiaan Hagen, Kingston (CA); Alexander Mohammadian, Caledon, CA (US)

(21) Appl. No.: 18/885,091

(22) Filed: Sep. 13, 2024

Related U.S. Application Data
(60) Provisional application No. 63/538,528, filed on Sep. 15, 2023.

(51) Int. Cl. F16D 28/00; F16D 11/00; H02K 7/108

(52) U.S. Cl. CPC F16D 28/00; F16D 11/00; H02K 7/108

(57) ABSTRACT

An actuator includes a motor operable in first and second opposite actuation directions, a member that is driven by the motor during at least the first actuation direction, and a clutch mechanism. A force generated by the motor in the first actuation direction engages the clutch with the driving member and the force is transferred to the driving member. The driving member is maintained in position against a back-driving force by the clutch when the motor is actuated in the first direction and the driving member is back-drivable when the clutch is disengaged. The actuator may be modular and an actuator system may include two or more of the actuators and a controller that implements a control strategy to control speed and/or power of the system output by one or more of recruiting individual actuators, controlling actuation frequency of the actuators, and controlling timing of actuation of recruited actuators.

### RELATED APPLICATION

This application claims the benefit of the filing date of Application No. 63/538,528, filed on Sep. 15, 2023, the contents of which are incorporated herein by reference in their entirety.

### FIELD

This invention relates to actuators and actuator systems suitable for applications such as robotics. More specifically, the invention relates to linear actuators and recruitable actuator systems.

### BACKGROUND

Robotics building blocks may be categorized as sensors, control theory, processing power, and actuators. Sensors, control theory, and processing power have advanced greatly over the past several decades whereas comparatively less improvement has been made on actuators, particularly where efforts have focused on improving existing actuator technology. Bio-mimicry is a rapidly evolving field of actuator design that shows promise as exemplified in applications such as gecko tape, aquatic robots, vine robots [1] [2] [3].

Another example is the pneumatic artificial muscle (PAM) which extends and contracts based on pressure changes in an expandable bladder placed inside a braided mesh sleeve fixed at each end.

Increasing the pressure in the system causes the structure to buckle outwards due to the bias introduced by the braided mesh reinforcement which in turn brings the two fixed ends closer to each other, mimicking a muscle contraction [4] [5]. These systems are lightweight and able to provide high contractile forces dependent on wall thickness and bladder size [6] and can be integrated with ratcheting mechanisms to increase the stroke length [7]. However, a drawback is that disengaging the actuator requires all pressure in the system to be removed.

More recently a hydraulically amplified self-healing electrostatic actuator (HASEL) was proposed [8]. This approach uses stacked discs with opposing electrodes on either side filled with a liquid dielectric. When a voltage is applied to the electrodes, the liquid is displaced and the disc is elongated axially. The discs may be stacked in any configuration which allows for combining actuators to provide an increase in force and stroke length through parallel stacking and series stacking, respectively [9]. However, the requirement for voltages of several kV or higher imposes limitations on practical implementations.

### SUMMARY

According to one aspect of the invention there is provided an actuator, comprising: a motor operable in first and second substantially opposite actuation directions; a driving member that is driven by the motor during at least the first actuation direction; a clutch that passively engages the driving member during the first actuation direction of the motor; wherein a force generated by the motor in the first actuation direction maintains the clutch engaged with the driving member and the force is transferred to the driving member; wherein the driving member is maintained in position against a back-driving force by the clutch when the motor is actuated in the first direction; wherein the driving member is back-drivable when the clutch is disengaged.

In one embodiment, the clutch is disengaged when the motor is actuated in the second direction.

In one embodiment, the motor is electrically actuated.

In various embodiments, the motor comprises one or more of a voice coil, a solenoid, and a shape memory alloy, or the motor is based on a pneumatic, hydraulic, combustion, or liquid-amplified zipping mechanism.

In one embodiment, the clutch comprises a wedge plate.

In one embodiment, the actuator comprises a modular topology adapted for use in a recruitable actuator system comprising two or more said actuators.

Another aspect of the invention provides actuator system comprising: two or more actuators as described herein; and a controller.

In one embodiment, the controller implements a control strategy that controls speed and/or power of the system by one or more of recruiting individual actuators, controlling actuation frequency of the actuators, and controlling timing of actuation of recruited actuators.

In one embodiment, the controller implements the control strategy by applying substantially the same input electrical power to each actuator.

In one embodiment, the two or more actuators are arranged in a series, parallel, or series-parallel configuration.

In one embodiment, an actuator that is not recruited remains idle and the driving member of the actuator that is not recruited is substantially freely back-drivable by the system.

Another aspect of the invention provides a method for implementing an actuator, comprising: providing a motor operable in first and second substantially opposite actuation directions; providing a driving member that is driven by the motor during at least the first actuation direction; providing a clutch that passively engages the driving member during the first actuation direction of the motor; wherein a force generated by the motor in the first actuation direction maintains the clutch engaged with the driving member and the force is transferred to the driving member; wherein the driving member is maintained in position against a back-driving force by the clutch when the motor is actuated in the first direction; wherein the driving member is back-drivable when the clutch is disengaged.

In one embodiment, the clutch is disengaged when the motor is actuated in the second direction.

In one embodiment, the motor comprises one or more of a voice coil, a solenoid, and a shape memory alloy, or the motor is based on a pneumatic, hydraulic, combustion, or liquid-amplified zipping mechanism.

In one embodiment, the actuator comprises a modular topology adapted for use in a recruitable actuator system comprising two or more said actuators. Embodiments may include using a controller to control actuation of the two or more actuators.

In one embodiment, the controller implements a control strategy that controls speed and/or power of the actuator system by one or more of recruiting individual actuators, controlling actuation frequency of the actuators, and controlling timing of actuation of recruited actuators.

In various embodiments, the two or more actuators are arranged in a series, parallel, or series-parallel configuration.

In one embodiment, an actuator that is not recruited remains idle and the driving member of the actuator that is not recruited is substantially freely back-drivable by the system.

Another aspect of the invention provides a controller for an actuator system comprising two or more actuators, the controller including a processor and non-transitory computer-readable storage media containing stored instructions executable by the processor, wherein the stored instructions direct the processor to perform calculations to generate output control signals to the two or more actuators, the control signals including signals that initiate priming and power strokes of the two or more actuators according to phase control including recruitment of the two or more actuators and/or a timing function to control timing of signals for the recruited two or more actuators; wherein the controller implements a feedback loop wherein the actuator system output is sensed by one or more of a force, position, velocity sensor, accelerometer, inertial measurement unit and one or more sensed values are compared to target value and a result of the comparison is used as input to the phase control to determine a number of actuators to be recruited from the two or more actuators, and the timing function to determine the timing of the control signals to achieve the target values.

Another aspect of the invention provides non-transitory computer-readable storage media containing stored instructions executable by a processor, wherein the stored instructions direct the processor to perform calculations to generate output control signals to control two or more actuators in an actuator system; wherein the control signals include signals that initiate priming and power strokes of the two or more actuators according to phase control including recruitment of the two or more actuators and/or a timing function to control timing of signals for the recruited two or more actuators; wherein the controller implements a feedback loop wherein the actuator system output is sensed by one or more of a force sensor, position sensor, velocity sensor, accelerometer, and inertial measurement unit and one or more sensed values are compared to target value and a result of the comparison is used as input to the phase control to determine a number of actuators to be recruited from the two or more actuators, and the timing function determines the timing of the control signals to achieve the target values.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a schematic diagram of an actuator according to one embodiment.

FIG. 2 is a diagram showing four stages of operation of an actuator according to the embodiment of FIG. 1.

FIG. 3 is a diagram showing modes of operation of an actuator according to the embodiment of FIG. 1.

FIGS. 4A and 4B are flow charts for control algorithms used to control a plurality of actuators in recruitable actuator systems, according to embodiments.

FIG. 5A is a plot showing a relationship between power strokes, priming strokes, and force output of a system of three actuators connected in series operating at 10 Hz, based on the embodiment of FIG. 1.

FIG. 5B is a plot showing control signals for the three actuators in the actuator system used to produce the result of FIG. 5A.

FIGS. 6A and 6B are control signal diagrams of a single actuation cycle for varying actuator recruitment configurations of a system with six actuators, wherein FIG. 6A shows offset or phase configurations increasing rightwards, and FIG. 6B shows synchronized and mixed configurations and a schematic representation of the six actuators in a top down view.

FIG. 7 is a plot comparing experimental and simulated speed results obtained by increasing both the frequency and number of actuators in an asynchronous (phase) configuration.

FIG. 8 is a plot comparing experimental and simulated speed results obtained by increasing both the frequency and number of actuators in synchronous and asynchronous (phase) configurations.

FIG. 9 is a plot comparing experimental and simulated force results obtained by increasing both the frequency and number of actuators in an asynchronous (phase) configuration.

FIG. 10 is a plot comparing experimental and simulated force results obtained by increasing both the frequency and number of actuators in synchronous and asynchronous (phase) configurations.

FIG. 11 is a schematic diagram of an experimental apparatus used for closed loop P control and velocity tracking linear disturbance rejection control with phase recruitment experiments.

FIGS. 12A-12C are plots showing results of closed loop position tracking P control trials with simulation results when operating at 1 Hz, 5 Hz, and 20 Hz, respectively; wherein position is the distance between a position sensor and the end of the driving rod, and phase is the actuator recruitment control signal ranging from 6 (all actuators recruited) to 1 (single actuator recruited).

FIGS. 13A-13C are plots showing results of velocity tracking linear disturbance rejection control with phase recruitment trials when operating under a load of 0 N, 0.8 N, and 2.2 N, respectively, with three trials each; position is shown on the top portion of each plot with target velocity shown with a dashed line, and phase is the actuator recruitment control signal.

FIGS. 14A and 14B are plots showing results for angular target tracking control trials, wherein FIG. 13A shows repeat target angle tests at 20 Hz and a target angle of 45 degrees, and FIG. 14B shows multi-target angle tests at 15 Hz, for targets of 30, 45, 60, and 75 degrees and holding at each position for 3 s, and phase is the actuator recruitment control signal input shown in the lower portion of FIG. 14B.

FIGS. 15A and 15B are diagrams of an actuator based on a solenoid motor, according to one embodiment.

FIGS. 16A and 16B are diagrams of an actuator based on a pneumatic motor, according to one embodiment.

FIG. 17 is a diagram of an actuator based on a combustion motor, according to one embodiment.

FIGS. 18A and 18B are diagrams of a clutch mechanism, according to one embodiment.

FIGS. 19A and 19B are diagrams of a clutch mechanism, according to one embodiment.

FIG. 20 is a diagram of a clutch mechanism, according to one embodiment.

FIGS. 21A and 21B are diagrams of a clutch mechanism, according to one embodiment.

FIGS. 22A and 22B are diagrams of an actuator based on a liquid-amplified zipping motor, according to one embodiment.

### DETAILED DESCRIPTION OF EMBODIMENTS

According to one aspect, the invention provides actuators and actuator control systems that are capable of outputting high force and high speed, disengaging with minimal energy input, enable precise force control, and are highly back-drivable with minimal or no backlash. Embodiments are suitable for use in robotic applications, where high force enables a broad range of dynamic movement, high speed enables dexterity, light weight with high power-to-weight ratio provides better motion control, and the ability to disengage with minimal energy input (i.e., passively) improves overall efficiency by not using energy or minimizing energy use for certain operations. An actuator as described herein that can easily and freely disengage, similar to human muscle, may be used in robotic applications such as tools and wearable strength enhancers that minimally affect a user's range of motion and only provide force when requested by the user, as well as improve efficiency of walking robots. Actuator embodiments are adaptable to a wide range of form factors and are modular and may be implemented in recruitable multiple actuator systems, enhancing such adaptability and utility in robotic tendon and power transmission structures. Implementations may include redundant modular actuator topologies which can be exploited via cyclic power activation. Actuator embodiments may be substantially freely back-drivable, allowing leveraging of intrinsic dynamics of robotic structures to maintain passive mechanical stability, improve energy efficiency, and gain an increased range of motion through joint actuation. For example, in a walking robot application hip actuation without associated back-driving impedance allows free dynamic motion during ‘leg swing’ conducive to high gait efficiency, while enabling the application of torque at the hip for improved controllability of step placement and timing.

As used herein, the terms “actuator” and “actuator module” refer to a mechanical device that is capable of producing an output force upon input of energy. An actuator includes one or more driving units, each driving unit referred to herein as “motor”, a clutch mechanism, and a driven member. As used herein, the term “back-drive” or “back-drivable” refers to the ability of an actuator or a motor to be driven by its attached load when the input power is removed. An actuator or a motor that is highly back-drivable offers little resistance to being back-driven by the attached load or an external force.

As used herein, the term “substantially” means that the recited characteristic, parameter, and/or value need not be achieved exactly, but that deviations or variations, including for example, tolerances, measurement error, measurement accuracy limitations, and other factors known to those skilled in the art may occur in amounts that do not preclude or significantly impact the use or operation of an intended feature. A characteristic that is substantially absent may be one that is very small such that it is within the noise, beneath background, or at or below the detection capabilities of the measurement technique being used.

According to embodiments, an actuator comprises a modular, reciprocating, discrete unit with a force generating element (i.e., a motor), a linear output driving member (also referred to as a driven member), and an associated passive locking mechanism (e.g., a clutch). An actuator may also be referred to as an actuator module, insofar as actuator embodiments may be modular and modules may be mechanically connected or linked together in series, parallel, and series-parallel configurations to provide actuator systems wherein the configurations may be adapted for various applications and optimized for speed and force accordingly. In some embodiments the force generating element is powered electrically. Examples of force generating elements may include, but are not limited to, a voice coil, a solenoid, a shape memory alloy, and combinations thereof. In some embodiments the force generating element may be fluid powered using, e.g., hydraulic or pneumatic pressure. In some embodiments the force generating element may be powered by combustion of a fuel (e.g., a chemical, fossil fuel, alcohol, etc.). In some embodiments the force generating element may be powered by a liquid-amplified zipping mechanism. Embodiments provide reciprocating actuator modules that may facilitate direct drive, low impedance back-drivability, high power actuation of dynamic robotic systems. Embodiments are described herein primarily with respect to output driving members implemented with a rod, shaft, etc. However, embodiments may also be implemented with a flexible driving member such as a cable, rope, chain, etc. Such embodiments may have utility in certain applications, e.g., where back-drivability by a connected load is not required or can be achieved by other mechanisms.

Actuator embodiments may be optimized for low friction. With high static/kinetic friction actuator efficiency would be degraded because the actuator would be working to overcome the friction during operation. Additionally, actuator back-drivability would be hampered with higher frictional forces. For example, high frictional forces during back-driving would have to be overcome while the actuator is in an idle state, possibly resulting in the system causing more strain than force addition. Similarly, higher frictional forces would greatly reduce the energy saved when using an actuator system in an application such as driving a walking robot, since the system would absorb inertia and gravitational energy during the passive component of the gait cycle which would otherwise be used to enhance system performance.

According to another aspect, the invention provides actuator systems comprising two or more actuators, and controllers and software for actuator systems. Embodiments may employ modular actuator topologies based on actuators described herein. Embodiments may include recruitable actuator systems and control methods wherein speed and/or power of the system may be controlled by activating individual actuators rather than increasing input electrical power to a single actuator. Actuator systems may be implemented connecting actuators in series, parallel, and series-parallel configurations to achieve desired stroke length and scalable mechanical power output and speed, and enable high power output through recruitment of multiple low-power actuators. Control may be implemented by controlling timing and/or frequency of activation of individual actuator power cycles. Embodiments include controlling actuators working together synchronously, by synchronizing power strokes, asynchronously, by offsetting power strokes, or combinations thereof. Whereas each actuator power stroke is a discrete action, an actuator system with a plurality of actuators may be controlled so that multiple power strokes occur over a short period of time such that the combination of discrete actions results in a substantially continuous output. Accordingly, an actuator system can achieve fine adjustment of its output (effector) position in 3D space according to an appropriate command input, allowing it to follow arbitrary trajectories.

The controller may include an electronic processor and a memory. The processor may be, for example, a digital controller such as a microcontroller unit (MCU). The processor may include processing capabilities as well as an input/output (I/O) interface through which the processor may receive one or more input signals (e.g., position sensor signals, inertial measurement unit (IMU) sensor signals, operating signals, force sensor signals, signals from other sensors such as thermal sensors, etc.) and generate output control signals for one or more actuators. The memory may be provided for storage of data and instructions or code (i.e., an algorithm, such as a controller algorithm, controller logic, software, etc.) executable by the processor. The memory may include various forms of non-volatile (i.e., non-transitory) computer readable media including flash memory or read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). The controller may include a driver circuit or device to interface an output control signal with an actuator.

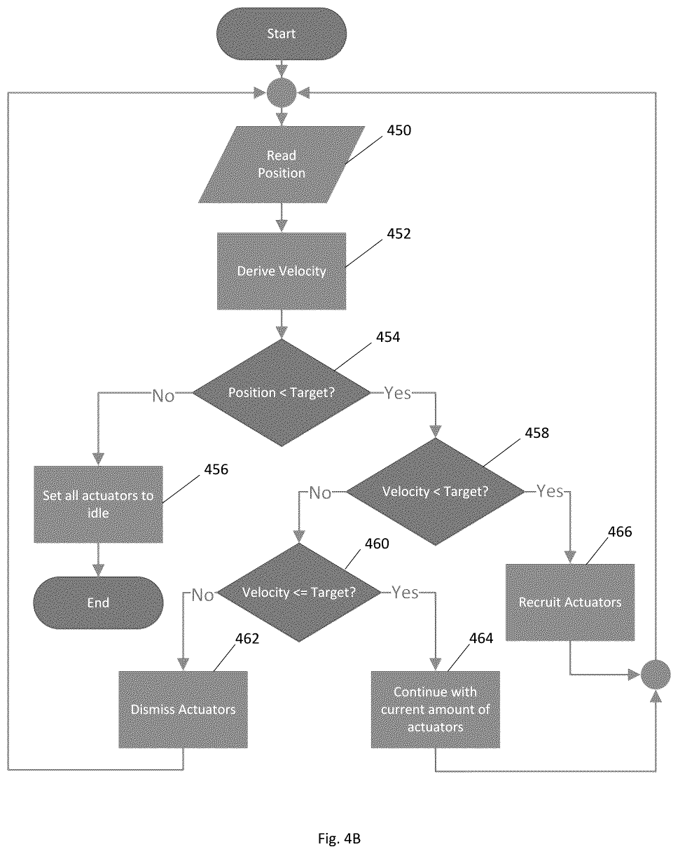

The memory stores executable code (i.e., software) including control logic, one or more algorithms, etc., which may be configured to control operation of the actuators and optionally the overall operation of an actuator system in accordance with a desired control strategy. For example, the control logic, when executed by the processor, may be designed to generate, in response to one or more input signals, signals that activate the actuators in a synchronous, asynchronous, etc., configuration. The control logic may include programmed logic blocks to implement specific functions, for example, including without limitation, proportional control, proportional-integral control, startup and/or shut down strategy, etc. The memory may also store, e.g., a lookup table that may be accessed by the control logic. Non-limiting examples of control strategies, or parts thereof, that may be implemented separately or in various combinations in controllers according to embodiments are described in Examples 2 and 3, and shown in FIGS. 4A and 4B.

Embodiments will be further described by way of the following non-limiting Examples.

### Example 1

This example describes an electrical actuator unit that can be modularly attached to a single driving member (e.g., a rod) which provides output force to interact with the environment. Multiple actuators may be mechanically connected together and activated simultaneously in asynchronous and/or synchronous configurations in order to adjust the speed and/or force of the rod as required. When no electrical power is applied to the actuator it enters an idle state in which the rod can be freely driven by external force, by the attached load, etc.

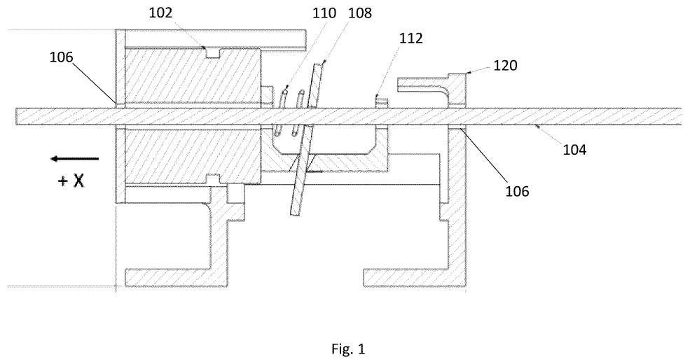

FIG. 1 is a schematic diagram of an actuator according to one embodiment based on a non-commutated DC linear actuator, also referred to as a direct drive linear motor, voice coil, or simply motor. Referring to FIG. 1, the motor 102 is mounted in a housing 120 and configured to accommodate a driving rod 104 passing therethrough with its longitudinal axis substantially aligned with the axis of movement of the voice coil. The driving rod 104 passes through a clutch mechanism which in this embodiment is implemented as a wedge plate 108 with biasing spring 110, supported by a wedge plate housing 112. The driving rod 104 may be guided and supported by one or more guides, bushings, or bearings 106 that are fixed to the housing 120 and/or wedge plate housing 112, etc. The wedge plate mechanism provides friction locking of the driving rod 104. The motor may be driven in either direction, corresponding to a priming stroke and a power stroke (as described in detail below) depending on the polarity of DC current applied to the voice coil. The application (e.g., duration, timing, polarity, etc.) of DC current to the motor may be controlled by a controller as described herein. The arrow “+X” shows the direction of travel of the driving rod during the power stroke of the motor.

For initial investigations a prototype was built with overall housing dimensions of approximately 40 mm long and 30 mm high, and a motor (voice coil) diameter of 15.9 mm. The housing was conveniently fabricated by 3D printing. The motor was chosen for its ability to linearly reciprocate at a rapid pace with a full stroke at frequencies up to 40 Hz and the ability to operate with a partial stroke up to 80 Hz. The actuator had an output full stroke length of 3 mm per cycle at a force of 1.19 N when supplied with a DC current of 1 A at 3.5 V. The actuator design is modular and readily scalable.

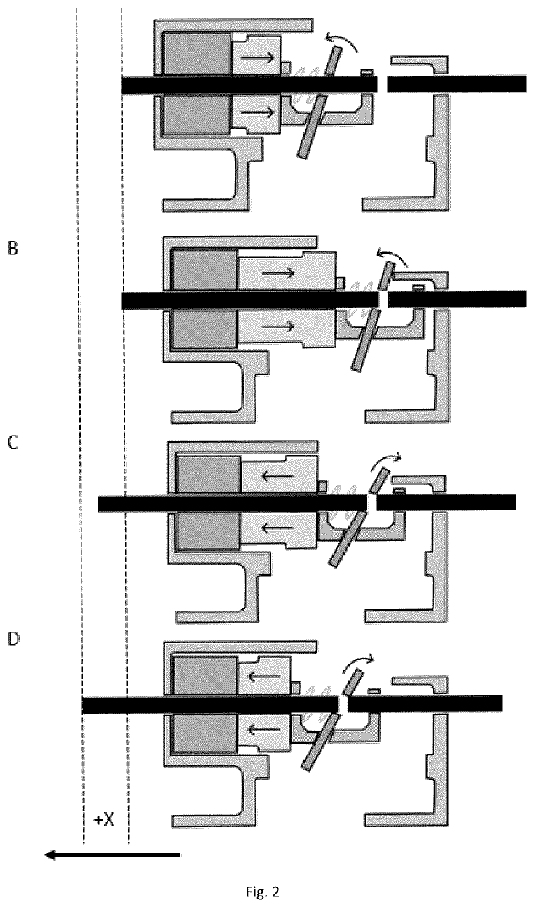

The actuator operation will now be described in four stages as shown with reference to FIG. 2A-D, where the vertical dashed lines show the position of the driving rod during the four stages. In FIG. 2A, the priming stroke begins when the motor is energized with a DC current at a first polarity and extends, pushing the wedge plate housing 112 in the −X direction. During this phase the driving rod 104 stays stationary as the motion of the motor causes the wedge plate 108 to move into its disengaged position, as indicated by the small curved arrow. The motor continues in this direction until it is fully extended, shown in FIG. 2B, completing the priming stroke. A stopper, not shown in the figure, may be provided to prevent the motor from extending past its maximum stroke length (e.g., 3 mm). At this stage, the top of the wedge plate 108 contacts the housing 120, holding it in its disengaged position. The motor may be held in this position by maintaining the DC current to the voice coil, or freely moved to this position when the motor is de-energized and the rod is pulled in the −X direction by an outside force. While the actuator is in this stage, the driving rod 104 may be moved in either direction (+X or −X) as the wedge plate 108 is does not engage the driving rod in a friction lock. While the wedge plate 108 is in the disengaged position, the overall friction of the wedge plate on the driving rod is minimal, and the driving rod is substantially freely back-drivable. As shown in FIG. 2C, the power stroke begins when the polarity of the DC current applied to the motor is reversed and the motor begins retracting, moving the wedge plate housing 112 in the +X direction. This causes the wedge plate to move into its engaged position (as indicated by the curved arrow) wherein it achieves a friction lock on the driving rod. As shown in FIG. 2D, as the motor unit continues retracting in the +X direction, the wedge plate is locked to the driving rod and the motor continues to pull the driving rod in the +X direction until the motor reaches the end of its stroke in the +X direction. The friction lock of the wedge plate ensures that substantially all the force produced by the motor is applied to the driving rod. The motor may be held in this position by maintaining the DC current to the voice coil at the reversed polarity, and while held in this position the wedge plate remains locked on the driving rod.

It will be appreciated that the limiting factor in the strength of the actuator is not the strength of the friction lock, but the force generated by the motor to keep the wedge plate in a position where it can remain engaged. When a sufficiently high force is applied to the driving rod, the motor will move causing the wedge plate to contact the housing and disengage, as designed. In the experimental prototype, a force greater than 9.8 N applied directly to the driving rod was required to forcefully overcome the friction lock.

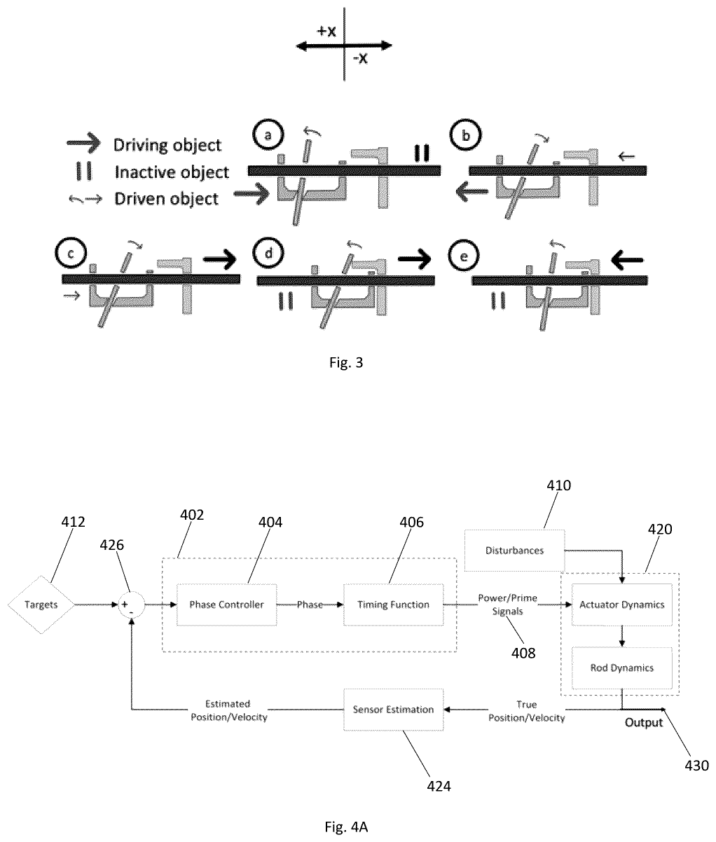

FIGS. 2A-2D show cycling of the friction locking mechanics of the wedge plate. However, the friction locking mechanism does not require the motor to be driven and can be engaged and disengaged passively by external force. This is because movement of the driving rod and movement of the wedge plate housing have opposite effects on the wedge plate friction lock. Depending on the direction of motion, moving either the wedge plate housing or the driving rod can engage the friction lock and pull both elements in the direction of motion. How the friction locking mechanism works with respect to both the driving rod and wedge plate housing movement is shown in FIG. 3. When the driving rod is being moved by an external force in the −X direction, FIG. 3 c and d, the wedge plate achieves a friction lock on the driving rod moving the wedge plate housing in the direction of the driving rod motion (c) until the wedge plate housing makes contact with the actuator housing at which point the wedge plate will be forced to disengage its friction lock (d) allowing the driving rod to continue freely sliding through. If the driving rod were to be moved in the +X direction (e) the wedge plate would naturally disengage and allow for free movement of the driving rod. FIG. 3 (a) and (b) show how the disengaging and engaging of the wedge plate works oppositely to the driving rod movement shown in (c), (d), and (e).

### Example 2

This example describes control algorithms that may be implemented by a controller in some embodiments.

Referring to the embodiment of FIG. 4A, a controller includes a portion 402 that performs calculations to generate output control signals 408 to the actuators including, for example, control signals that initiate priming and power strokes of the actuators (power/prime signals) according to phase 404, i.e., recruitment of actuators, and timing 406 of the control signals for the recruited actuators. The actuators respond 420 to the power/prime signals to produce a mechanical output 430. The actuator(s) output may be affected by the mechanical load, disturbances, etc. 410. The controller includes a feedback loop wherein an actuator(s) output, which may be one or more of force, position, and velocity may be monitored or sensed 424 (e.g., using force sensors, position/proximity sensors, accelerometers, IMUs, etc.). The sensed values are compared 426 to target values 412 and the result of the comparison is used as input to the phase controller 404 to determine the number of actuators to be recruited, and then the timing function 406 to determine the timing of the control signals to achieve the target values. Examples of calculations that may be performed by the controller are presented in Example 3.

The embodiment of FIG. 4B is a control process in an algorithm for position and velocity tracking. The position of a member, driving rod, effector, etc. is measured 450 using a sensor (e.g., position/proximity sensor, IMU, etc.), the sensed value is used to determine velocity 452, and the position and velocity are used in comparisons. At 454, if the position is not less than the target value it is assumed that the position has reached the target value and no actuators are actuated (i.e., all actuators are set to idle) 456. Alternatively, the algorithm may return to read the position again at 450 so that the position is continuously updated. If the position is less than the target value, the velocity is compared to a target value 458. If the velocity is not less than the target value a further comparison determines whether the velocity is greater than or equal to the target value 460. If the velocity is greater that the target value a determination is made to dismiss (i.e., set to idle) one or more actuators 462, and the process loops back to obtain a new position reading 450. If at 460 the velocity is equal to the target value a determination is made to continue with the same number of actuators recruited 464, and the process loops back to obtain a new position reading 450. If at 458 the velocity is less than the target value a determination is made to recruit one or more actuators 466, and the process loops back to obtain a new position reading 450.

### Example 3

This example describes grouped actuator systems and recruitment-based control methods using a plurality of actuators as described in Example 1, and a simulation model for the actuator systems. Other actuator designs may of course be used.

According to embodiments each individual actuator is considered as a discrete part of the system. When more power is needed in the system more actuators are recruited or activated, i.e., switched from idle (no power) to active (reciprocating). Both synchronized and offset approaches were investigated.

FIG. 5A shows the results of a blocked force test with three actuators connected together in series and working at a 120° phase offset, or “3 phase”. The system of three actuators was operated at 10 Hz with an actuation cycle (power and priming stroke) of 0.1 s, each actuator undergoing 10 power strokes and 10 priming strokes, resulting in a total of 30 power strokes per second. The output driving rod acted on a force sensor that recorded the total output force produced by the system. Here each actuator was operating with a power stroke for half of the actuation cycle (0.05 s), providing force onto the force sensor, and a priming stroke for the other half of the actuation cycle, providing no force. The timing of each actuator undergoing a power stroke was offset by 120° resulting in a force profile that peaked every ⅓ of the cycle, the peak resulting from two actuators undergoing a power stroke simultaneously, ensuring that a force was constantly applied on the force sensor to prevent unwanted back-driving. The controls sent to each actuator by the controller, wherein actuators were controlled to cycle between power strokes and priming strokes, are shown in FIG. 5B. The consistency of the system can be seen from FIG. 5A which shows an overlay of 40 cycles at an actuation frequency of 10 Hz, with an average standard deviation of +0.063 N between cycles. The actuation frequency is a metric that defines how many cycles a single actuator completes per second.

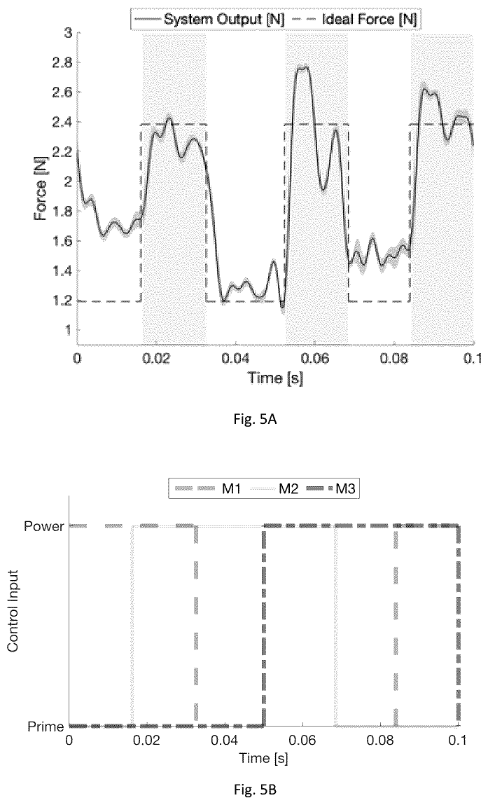

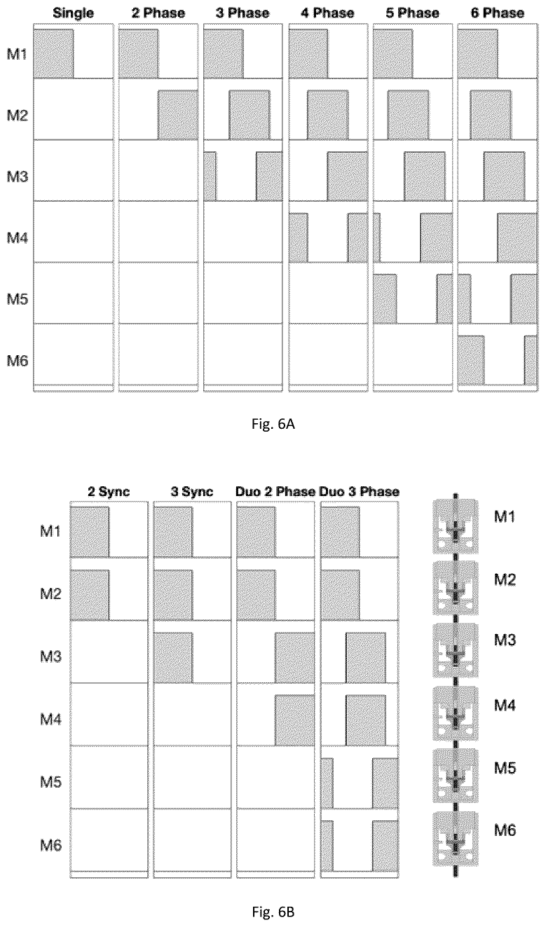

The offset control method is scalable and may be applied to other numbers of actuators and may use other degrees of offset, as well as any combination of syncing and offsetting. For simplicity only a limited set of combinations were tested during preliminary trials using between two and six actuators and offsets between 180° and 60°, respectively. Simplified outputs of these combinations can be seen in FIGS. 6A and 6B. For example, FIG. 6A shows actuation cycles for one to six actuators (M1 to M6) connected in series as recruitment proceeds from one (“Single”) to six (“6 Phase”) actuators. As another example, FIG. 6AB shows actuation cycles for up to six actuators (M1 to M6) connected in series with two actuators synchronized (“2 Sync”), three actuators synchronized (“3 Sync”), two groups of two synchronized actuators offset (“Duo 2 Phase”), and three groups of two synchronized actuators offset (“Duo 3 Phase”). A schematic representation of the six actuators connected together in series is shown at the right hand side of FIG. 6B.

To test different control methods and sensor configurations prior to building a physical apparatus simulations were conducted using a model created in MATLAB (The MathWorks, Inc.) focusing on the recruitment aspect of the system. The main components of the model were the controller, actuator physics, and sensor estimate. The controller was split into two subsections, the phase controller and the timing function. The phase controller determined what phase, or number of actuators, the system should be using dependent on the estimated position/velocity of the rod and the goal position/velocity. The phase adjustments were dependent on the control method used and the approach was that if the current phase configuration is under-performing then more actuators will be recruited, if it is over-performing then actuators will be dismissed (set to idle). A timing function bridged the connection between the number of requested actuators from the phase controller and the actuators themselves. This function determined the actuation pattern of the simulated actuators depending on the number of actuators requested by the phase controller. If the phase controller determined that x actuators were required then the timing function created an actuation pattern of x actuators equally out of phase with each other using equation (1)

$$ω = \frac{1}{v ⋆ ρ} \qquad ( 1 )$$

where v represents the frequency of the system, p is the phase output from the controller and w is the equal time gap for which each recruited actuator will be actuated in a given actuation cycle (one period). The actuators that are a part of an actuation pattern undergo their cycle of power and priming strokes while the non-recruited actuators remain idle.

Individual actuators were modeled using the measured force output of the voice coils in addition to measured frictional values. This force estimation was translated to acceleration using the measured mass of the wedge plate and the driving rod at each time step before being integrated to calculate the driving rod velocity and position. The calculations used to estimate the overall system velocity and position include the power and priming stroke accelerations of individual actuators using equations (2) and (3)

$${α}_{Power}^{i} = \frac{- {F}_{VC} - {F}_{f}}{{m}_{rod} + {m}_{wedge}} * A \qquad ( 2 )$$

$${α}_{Prime}^{i} = \frac{{F}_{VC} - {F}_{f}}{{m}_{rod} + {m}_{wedge}} * A \qquad ( 3 )$$

where i denotes the actuator being fired, F_{VC} denotes the voice coil force, and A is a binary activation constant that is 1 when the actuator is active and 0 when it is idle. The actuator alternates between the power stroke and priming stroke once per cycle with each stroke being active for 50% of the cycle time. If either the power stroke or the priming stroke reach the voice coil stroke length of 3 mm within a cycle the simulation stops the actuator from moving but still treats it as if the simulated actuator is applying force on the driving rod if in the power stroke and disengaged if in the priming stroke.

After the individual actuation forces have been calculated the active power strokes are then summed using equation (4)

$${α}_{Rod} = {\sum }_{x = 1}^{j = 6} {α}_{Prime}^{i} \qquad ( 4 )$$

The newly calculated driving rod acceleration is then used with the previously calculated acceleration in order to estimate the velocity and position of both the driving rod and each individual actuator, with velocity calculated using

$$[ \begin{matrix}{υ}_{Rod} \\ {υ}_{Actuator}^{i}\end{matrix} ] = \int [ \begin{matrix}{α}_{Rod} \\ {α}_{Power}^{i} + {α}_{Prime}^{i}\end{matrix} ] dt \qquad ( 5 )$$

and position calculated using

$$[ \begin{matrix}{p}_{Rod} \\ {p}_{{Actuator}^{i}}^{i}\end{matrix} ] = \int [ \begin{matrix}{υ}_{Rod} \\ {υ}_{Actuator}^{i}\end{matrix} ] dt \qquad ( 6 )$$

As noted above the model can switch between the number of actuators recruited mid cycle allowing for quick testing of control methods focusing on actuator recruitment. Additionally, for experiments involving any form of sensor a noise function was included to mimic the noise of the sensor. This feature was included mainly to test different smoothing/filtering functions that may be applied to a control algorithm in order to maximize accuracy and minimize computing time given a noisy position estimate. Simulating these smoothing/filtering functions allowed rapid adjustment of how the sensor data were filtered and fed into the simulated phase controller in order to balance quick and accurate readings. The tweaked smoothing functions were then in turn applied to the actual physical system and provided similar results to the simulation, described below.

### Example 4

This example describes testing of actuator systems under various conditions including no load open loop operation, no load closed loop operation using recruitment based P control, and loaded closed loop operation using recruitment based velocity tracking, and testing how the system reacted to angle tracking with the actuator linear range of motion being transferred to angular using a model arm and at different target angles.

### A. Friction Parameterization

Actuators were optimized to minimize overall friction through calibrating rod/wedge plate hole ratios, spring constants/lengths, and wedge plate stoppage positions. Tests were conducted using a NANO-17 force sensor (ATI Industrial Automation, Inc., Apex, NC, USA) with a resolution of ±3.125*10⁻³ N which was used to push on the actuator driving rod both in the direction of motion and antagonistically (i.e., back-driving). Since the force sensor pushed on the rod at a constant velocity both the systems static friction and kinetic friction could be measured. However, it was found that the static friction was negligibly higher than the kinetic friction, resulting in the kinetic friction being the main parameter used for model calculations.

For the actuator of Example 1, the frictional force was 0.052±0.007 N when moving in the driving direction and 0.06±0.005 N when moving antagonistically. When six actuators were attached to the driving rod the highest recorded friction was 0.27±0.06 N when operating antagonistically resulting in the system having a frictional loss of only 4.5% of its maximum driving force.

### B. No-Load Operation

The forces and speeds of different configurations of series-connected actuators based on the embodiment of Example 1 were measured. Friction caused by adding more actuators to the system was determined in order to find out the theoretical limit of the systems modularity.

Force tests were conducted using an Arduino® Mega microcontroller (Arduino SRL, Monza MB, Italy) to control the timing of the actuators and a 1 kg load cell with a resolution of 0.005 Kg. The driving rod was parallel to the load cell apparatus to reduce torque and gravitational forces. Each configuration was tested twice and underwent 10 s of testing per trail, resulting in a minimum of 10 cycles being recorded for 1 Hz testing and up to 320 cycles for 80 Hz testing.

Speed tests were conducted by filming using a 960 fps high-speed camera and later analyzed using Kinovea kinematic analysis software. The position of the unloaded driving rod was tracked using high contrast markings allowing for the actuators average speeds to be extrapolated.

A total of 320 force trails, 528 speed trails, and 36 friction trails were conducted to get an accurate representation of the system outputs. All tests were done using open loop control as the purpose of the trials was to characterize how the system reacted using different numbers of recruited actuators and actuator frequencies.

Speed data was collected using 11 different configurations tested between 5 Hz and 80 Hz. These configurations varied between different stages of synchronous and asynchronous operation. For each configuration and frequency combination 3 trails were taken with 5 cycles being recorded per trial, resulting in 15 data points per configuration at each frequency.

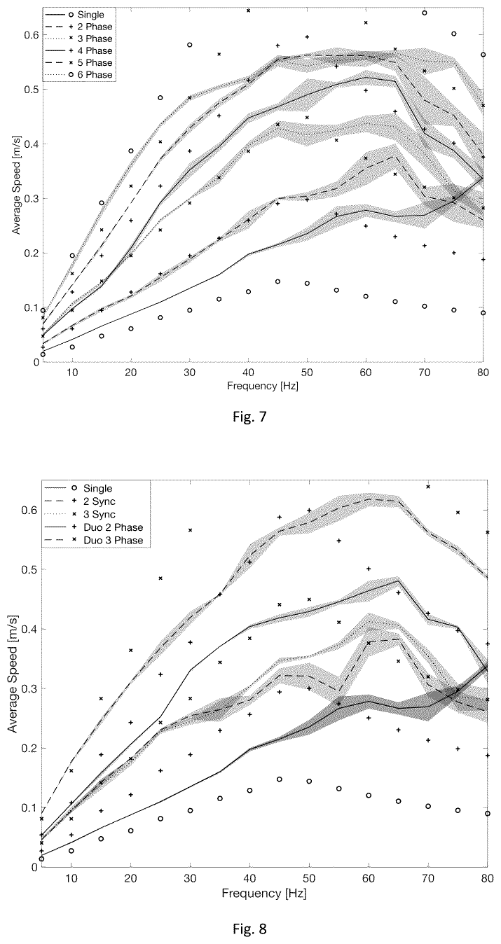

Results for asynchronous (phase) configuration are presented in FIG. 7 Referring to FIG. 7, it can be seen that by either increasing the number of actuators recruited asynchronously or increasing the frequency results in an increase in the driving rod speed. The increases happen at a linear rate until the operating frequency upper limit is reached, at about 50 Hz for a single actuator and 30 Hz for a system of six actuators (based on the embodiment of Example 1). The upper limit is reached when the motor unit (voice coil) does not have enough time to fully reach its 3 mm stroke length before changing from a priming stroke to a power stroke or vice-versa. In FIG. 7, simulated results, shown as markers, indicate a close relationship between predicted results and actual results. The outlier to the simulation is the single actuator trial. This is due to the fact that the simulation did not account for the driving rod maintaining its momentum after the actuator completed its power stroke. Not accounting for this momentum resulted in the experimental trials operating at higher speeds than the simulated results as the rod was able to maintain its speed during the priming stroke. This interaction only occurs with the single actuator as in higher phase configurations there will always be an actuator friction locked onto the rod, preventing momentum from continuously building.

FIG. 8 shows the results of varying speed trials using different synchronous configurations, i.e., when multiple actuators are undergoing a power stroke simultaneously, in the 2 Sync and 3 Sync configurations. FIG. 8 includes results for a combination of synchronous and asynchronous configurations, for 4 actuators with 2 sets of actuators operating simultaneously in a 2 phase, or alternating, pattern (Duo 2 phase), and for 6 actuators with 2 sets of actuators operating simultaneously in a 3 phase pattern (Duo 3 phase). Simulation results are shown with stars. With the purely synchronous configurations the same issue with the simulation not accounting for momentum is apparent, resulting in inaccurate speed estimations.

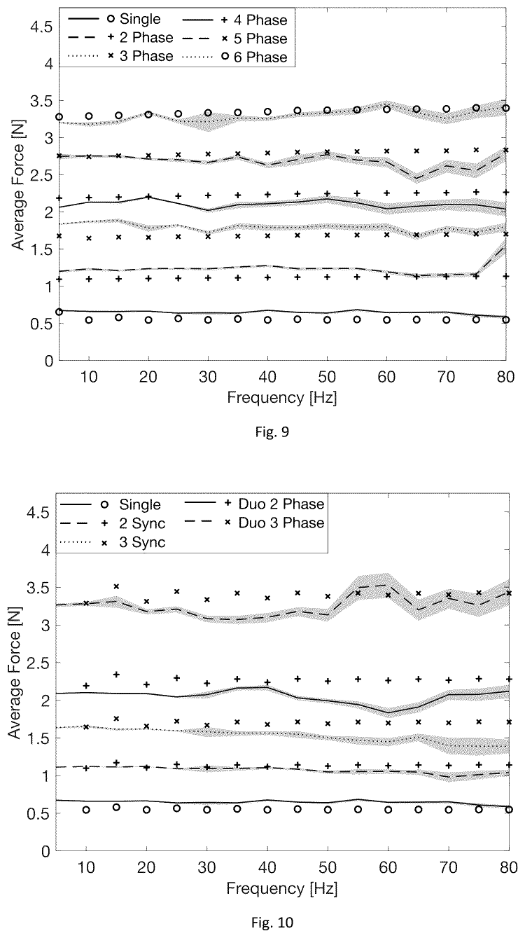

In addition to speed trials the same configurations were also tested using average blocked-force trials. The average blocked force refers to the average reading on the load cell per cycle. Since the overall force on the cell changes during phase operation due to actuator hand-off, the average force per cycle is a metric that can be more easily compared between different configurations and frequencies. Similar to the asynchronous speed trials the average force increased as the number of recruited actuators increased, from about 0.6 N for one actuator (single phase) to about 3.3 N for all six actuators (6 phase), as shown in FIG. 9. Unlike the speed trials however there was no increase in force correlated with an increase in frequency, as the force output was substantially constant as the frequency increased to 80 Hz. Overall the results were well correlated with the simulated results. Additionally, due to the lack of correlation between force and frequency when the actuators exceeded the frequency at which the full stroke length could be attained there were no ill effects on the system.

In general, results showed that the combination of synchronous and asynchronous configurations was more inconsistent than purely asynchronous counterparts. The experimental results (FIG. 10) showed that most of the synchronous force trials slightly under performed when compared to the estimated simulated values, while the asynchronous trials slightly over performed. The purely synchronous configurations also allow for the driving rod to be freely back driven during the priming stroke since during a portion of the operating cycle all actuators on the driving rod are disengaged and any external force can then freely move the driving rod in either direction. This is not ideal for any case where there is a constant load on the rod. Therefore, in most applications asynchronous configurations may be preferred as there will always be at least one actuator providing force on the driving rod.

### C. No-Load Closed Loop Control

Tests involved using proportional control (P-controller) implemented with an Arduino® Mega microcontroller with the goal being to stop the system at a target position. Unlike a P-controller that outputs an analog signal to a motor to increase/decrease its outputted mechanical power based on an increase/decrease in the supplied electrical power, embodiments use activation of actuators (recruitment) to increase/decrease mechanical output power. This control was implemented with the controller outputting integer values from 1 to 6 corresponding to the number of actuators to be activated at that time. When a signal of 6 is sent from the controller all 6 actuators are activated and the system is at its maximum force and speed output. When a signal of 1 is sent only a single actuator is activated while the rest remain inert, and the system will be at its minimum force and speed output. A signal of 0 corresponds to all actuators being idle. For these experiments the system had to reach a target position of 13.5 cm starting at a position of 2.5 cm from the system's position sensor.

P control experiments and experiments with linear disturbance rejection control with phase recruitment used the same experimental setup, shown schematically in FIG. 11. For experiments a Kp value of 120 was used and actuator frequencies of 1, 5, 10, 15, and 20 Hz were tested. This range was chosen as the position sensor used could update its readings at a maximum frequency of 20 Hz. Referring to FIG. 11, the experimental setup included six actuators 802 (numbered 1 to 6) connected together in series to the same driving rod 804, and position sensor 806, implemented with a VL53L1X time of flight ranging sensor (ST Microelectronics). The setup provided for weights 808 to be added to the load to represent disturbances for the linear disturbance experiments. Each actuator was electrically connected to the P-controller.

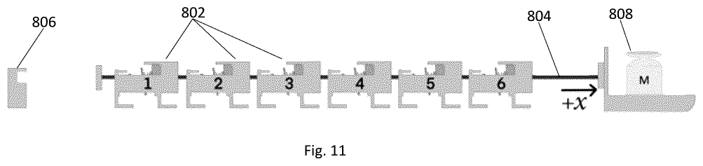

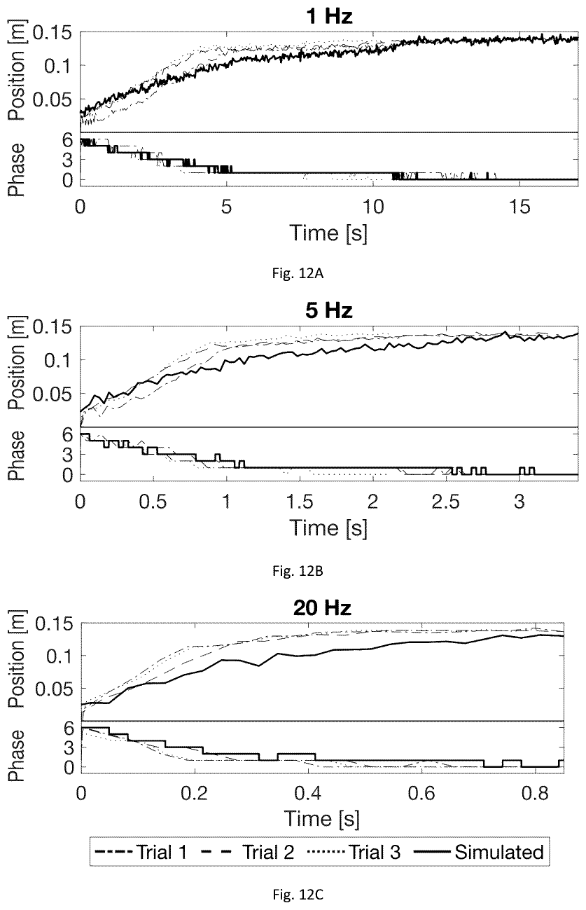

FIGS. 12A-12C show results for three trials for the system operating at 1 Hz, 5 Hz, and 20 Hz, respectively, and the simulation results. Under P control the system starts by outputting full power with all 6 actuators driving. As the system gets closer to its target goal the power is decreased by reducing the number of actuators recruited until the goal position is met and the system becomes idle. The experimental trials outperformed the simulations in terms of rise time at every frequency. This can be attributed to the simulation not accounting for the momentum of the rod to be increased while the actuators are switching between phases. Since the momentum is built upon in the physical experiments when switching between phases the speed of the physical system is slightly faster than the simulation resulting in a quicker rise time. The rise time increased linearly with an increase in operational frequency as the system reached its goal in 5 s at 1 Hz, 1 s at 5 Hz and 0.25 s at a 20 Hz actuation frequency.

D. Velocity Tracking Linear Disturbance Rejection Control with Phase Recruitment

A velocity tracking test was conducted with various disturbances. The goal of this test was for the actuator system to maintain a constant velocity of 0.02 m/s before stopping at the maximum range of 13.5 cm. The controller allowed the system to recruit up to 6 actuators in phase, doing so when it encountered a heavier obstacle that required more force to push.

In one embodiment a hysteresis-based control algorithm was used with the system having a set of moving bands which dictated the maximum and minimum number of actuators it could recruit. At the start of a trial all bands were set to 1. If the system was slower than the desired velocity for two consecutive position sensor readings, which were converted to an estimated velocity, then the upper limit band increased by 1 phase, while the lower limit band remained at 1. If the system remained below the expected velocity the upper limit band continued shifting upwards. Once the upper limit band reached the maximum of 6 it remained capped and the lower limit band began to increase. The inverse occurred when the system was overshooting its target velocity, as the system decreased the bands until it reached its goal.

While the bands dictate the maximum and minimum number of actuators that can be recruited at one time the actual number of recruited actuators can quickly adjust within the bands. Using an approximation of the system velocity from the position sensor the controller rapidly increased or decreased the number of recruited actuators depending on whether the system was overshooting or undershooting the target velocity. In this embodiment the control algorithm may be considered to include two routines: slow switching or how the bands are moving, and fast switching or how the phase output is moving in between the bands.

One purpose of this control embodiment was to compensate for noise generated by the position sensor. When differentiating the noisy position signal the resulting velocity was too noisy to use a more sophisticated PID controller. Additionally, applying a smoothing/moving average filter to the system slowed the system reaction time to what was considered less than ideal. A compromise was the control algorithm in addition to a small moving average filter to quickly filter out some noise which allowed for the controller to make more accurate adjustments faster. In general, the position sensor used was very noisy and was a limiting factor in these trials that negatively affected the results.

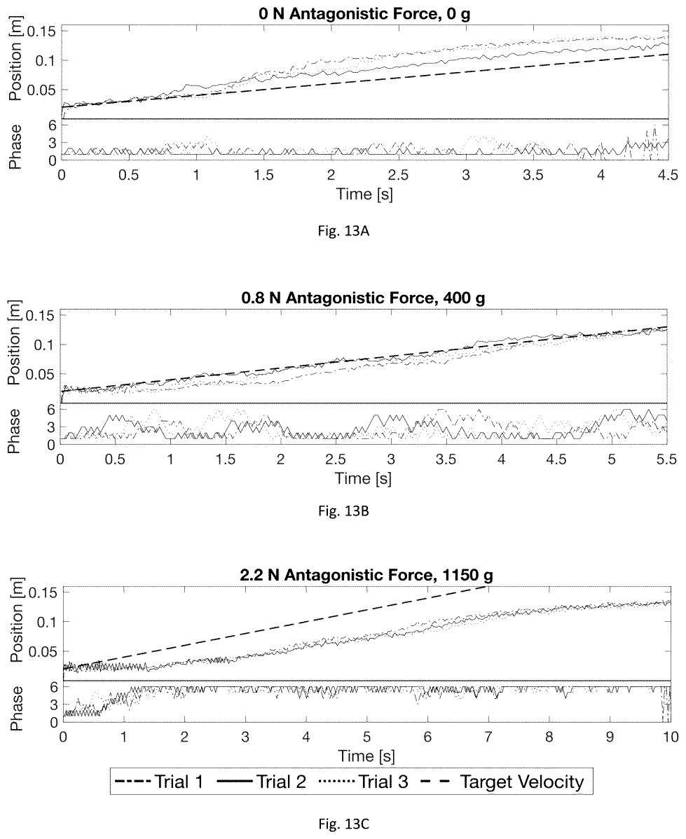

For all of the tests in FIGS. 13A-13C the actuator frequency was set to 5 Hz. This lower frequency was used due to the limitations caused by the resolution of the position sensor. By slowing down the actuation frequency it was possible to better see how the system reacted to disturbances as there were more data points for the controller to react to for each test.

FIG. 13A shows the velocity target algorithm being used on an unloaded system. Since the system has no opposing force the driving rod is able to move at a similar speed to the target velocity with only one or two actuators being recruited for a majority of the trial. When a load of 400 g was applied to the system (FIG. 13B) the velocity tracker was able to stay closer to its target as the system adjusted to the antagonistic force by increasing the number of actuators recruited, resulting in a range of all phases (1-6 actuators) being used at some point during the trial. With a load of 1150 g (FIG. 13C) it can be seen that the system reached its saturation point recruiting all 6 actuators to attempt to overcome the high load. The system fell short of the velocity target as the system with 6 actuators recruited could not provide enough power under this load.

### E. Angular Target Tracking Control

This test was intended to show how an actuator system based on the embodiment of Example 1 would perform in an application such as a walking robot or a wearable device. The system included six actuators, four oriented in the −X direction (counter-clockwise, CCW) to raise the load and two oriented in the +X direction (clockwise, CW), so that the driving rod could push and pull the load. The load was an arm which was attached at one end to a substrate with a hinge which acted as an elbow, so that it could be raised/lowered by the system to a target angle, with 0 degrees being the arm resting flat on the substrate and 90 degrees being the arm perpendicular to the substrate. The driving road was attached to the arm with a hinge joint, and the actuators were mounted on a platform that had the ability to tilt. A magnetic angle sensor was used to obtain the angle of the arm. Due to the back-drivable nature of the actuators the +X actuators were not used as gravity alone was sufficient to lower the arm when all actuators were in an idle state.

The controller was implemented with an ESP-32 microcontroller (Espressif Systems), enabling the magnetic angle sensor to be read at a rate of over 1 MHz. In one embodiment recruitment based position control was used in the control algorithm and velocity tracking was not used in order to reduce the level of complexity for the first round of testing. In one embodiment the controller implemented a 20 Hz control cycle and the goal was to move the arm to the target angle of 45 degrees using as few actuators as possible, starting at 1, if no noticeable movement was made after 2 cycles another actuator was recruited. The cycle repeats until the system either begins to move the arm toward the target angle or it runs out of actuators to recruit.

When the system reaches the target angle a holding pattern is activated, wherein the controller instructs all actuators to retract. With all the actuators retracted the wedge plates remain engaged on the driving rod and prevent it from back-driving. Since there were actuators facing both directions the driving rod was prevented from moving in either direction unless a force of 4.8 N was applied in the CW direction or 2.4 N in the CCW direction (each actuator can individually hold 1.2 N of force).

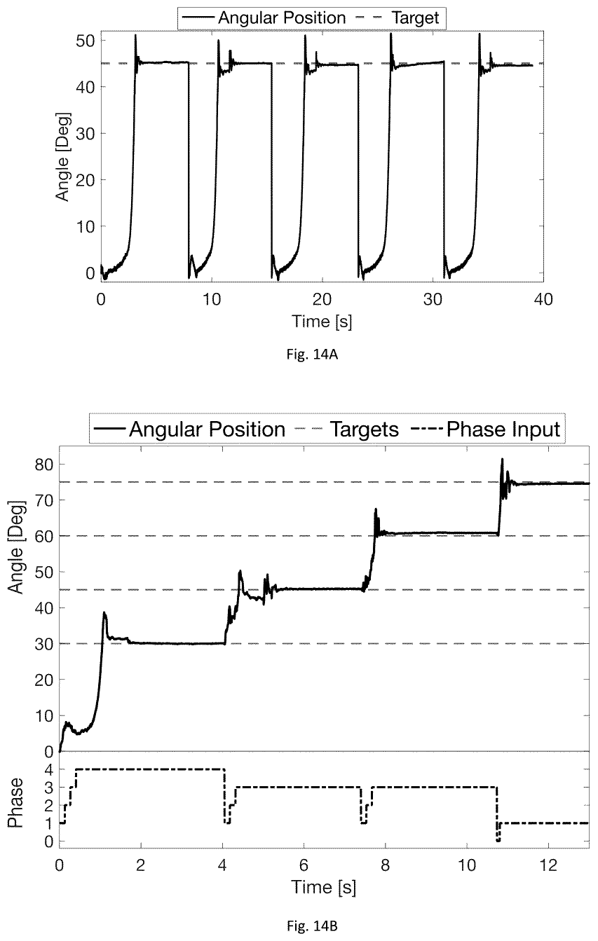

Results for repeat target tracking where the goal was to reach the same target angle of 45 degrees multiple times in one trial are shown in FIG. 14A. The holding pattern was held for 3 seconds before all actuators were set to idle and the unpowered arm dropped due to gravity to 0 degrees. During the holding pattern the system switched to a second mode of control wherein if the arm was under the target angle a single actuator is removed from the holding pattern, the antagonistic actuators are idle, and the single actuator begins to move the arm towards the target angle, rejoining the holding pattern when the target angle is reached.

Results for multi-target tracking where the goal was to reach four different target angles before resetting to 0 degrees are shown in FIG. 14B. The system was able to successfully reach the different target angles using a different number of recruited actuators for each target.

Multi-target testing again demonstrates the use of actuator recruitment as a form of control. Between the target angles of 0-30 the system used all four CCW actuators to overcome the high torque imposed by the arm at 0 degrees and low angles. As the arm angle increased fewer actuators were recruited with only 3 actuators being used to move from 30-45 degrees and 45-60 degrees and 2 actuators being used to move from 60-75 degrees.

### Example 5

This is another example of an electrical actuator unit that can be modularly attached to a driving member (e.g., a rod) which provides output force to interact with the environment. Embodiments according to this example may include one or more solenoids as the force generating element(s) to drive the rod. Although a single solenoid may be used, a pair or multiple solenoids arranged substantially symmetrically around the rod may be preferable as such arrangements result in the force generated by the solenoids to be distributed around the rod. The solenoids may be disposed parallel to the primary longitudinal axis of the driven member to work in parallel in driving the clutch mechanism. Multiple actuators may be mechanically connected together and activated simultaneously in asynchronous and/or synchronous configurations in order to adjust the speed and/or force of the rod as required. When no electrical power is applied to the actuator it enters an idle state in which the rod can be freely driven by external force, by the attached load, etc.

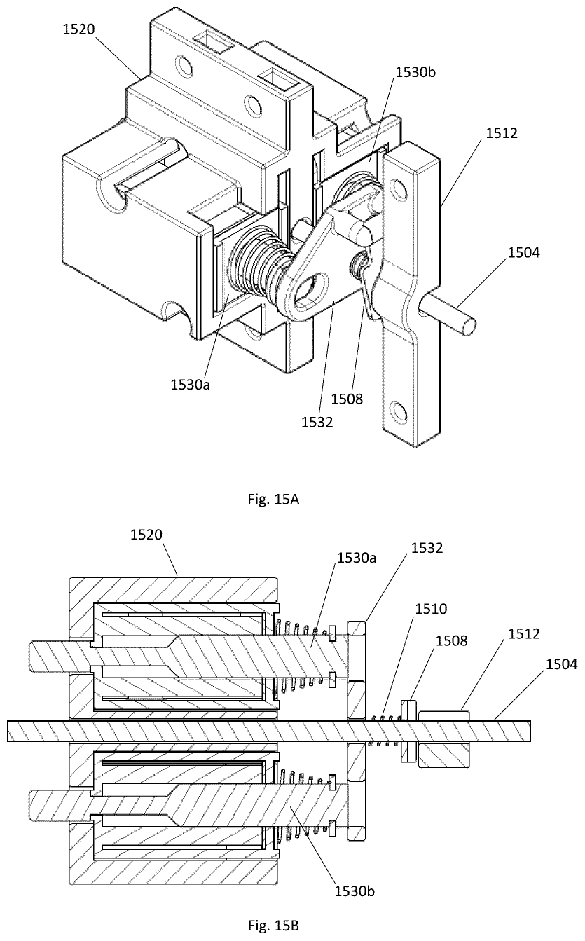

FIG. 15A is a diagram of an actuator according to one embodiment wherein the rod is driven by two solenoids, and FIG. 15B is a cross section through the solenoids. Referring to FIGS. 15A and 15B, the two solenoids 1530a and 1530b are disposed in the housing 1520 opposite each other on either side of the rod 1504. A driving plate 1532 connects the armatures of the solenoids 1530a, 1530b together so they effectively operate together when energized and when retracted by their springs when not energized. In this embodiment the clutch mechanism includes a clutch plate 1508 and spring 1510. The clutch plate is attached to the driving plate 1532 with a mechanism such as a hinge that allows it to pivot and thereby engage and disengage the driving rod 1504.

A cyclic control signal may be used to power the solenoid(s) together to produce oscillation. The parallel arrangement of solenoids around the driving rod allows, within space constraints, the power of each actuator module to be scaled up by adding more solenoids. Increasing the power of each actuator module in a grouped actuator system of two or more actuator modules contributes further to increasing the total power output of the complete actuator system, e.g., multiple modules in a series configuration acting out of phase. Axial grouping of solenoids as force generating elements is an effective way to increase power output in an actuator system, due to their compact size and low cost.

### Example 6

This is an example of a fluid powered actuator unit based on pneumatic or hydraulic pressure acting against a piston to create linear motion and force. A fluid powered actuator unit may be modularly attached to a driving member (e.g., a rod) which provides output force to interact with the environment. Multiple actuators may be mechanically connected together and activated simultaneously in asynchronous and/or synchronous configurations in order to adjust the speed and/or force of the rod as required. When the fluid powered actuator unit is not activated (i.e., fluid pressure is not applied) the actuator enters an idle state in which the rod can be freely driven by external force, by the attached load, etc.

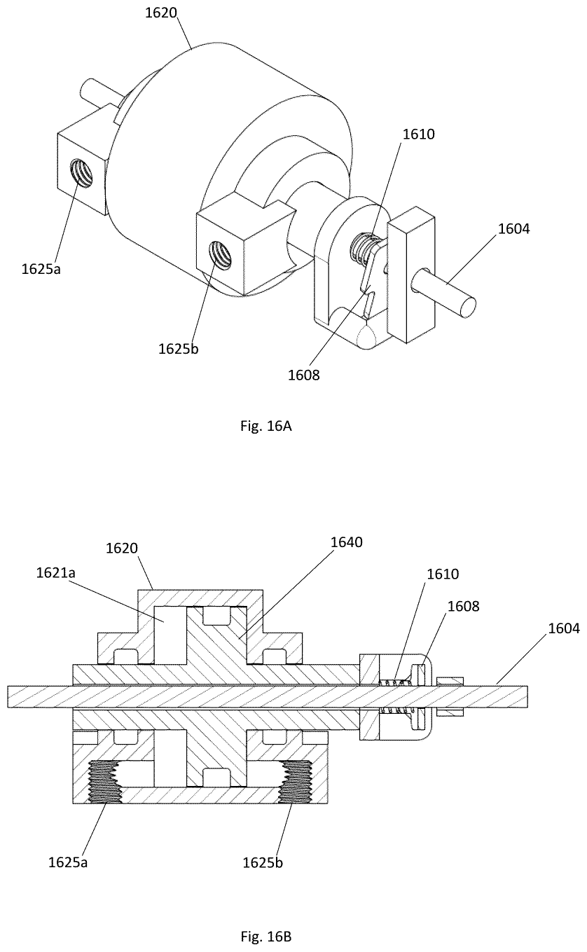

FIG. 16A is a diagram of an axial fluid powered actuator according to one embodiment, and FIG. 16B is a cross section through the actuator unit. Referring to FIGS. 16A and 16B, the actuator housing 1620 provides an axial internal expansion chamber. An axial piston 1640 is disposed in the expansion chamber. FIG. 16B shows the expansion chamber 1621a to the left of the piston 1640, when the piston is at the right limit of travel. Although not shown, it will be readily apparent that when the piston is at the left limit of travel the expansion chamber is to the right of the piston 1640. Fluid ports 1625a and 1625b are provided to facilitate the application and removal of fluid pressure to the expansion chamber fluid to the left and right of the piston, respectively. The piston drives the driving rod 1604 via a clutch mechanism, which in this embodiment includes a wedge plate 1608 and spring 1610. Thus, application of pressurized fluid through the left port 1625a drives the piston 1640 to the right, which causes the clutch to engage and exert a force on the driving rod 1604 to create the linear power. A requirement for the axial configuration where the piston 1640 is aligned with the driven member 1604 is that the expansion chamber must be properly sealed at the interface of the driven member while allowing the driven member to move through it.

A fluid actuator may also be implemented concentrically (e.g., similarly to a solenoid actuator such as the embodiment of FIGS. 15A and 15B) wherein two or more motors (each including an expansion chamber and piston) are arranged surrounding the driven member.

Cyclic actuation may be achieved directly by pairing each fluid actuator module to its own solenoid valve which may be controlled using a cyclic power signal. Such a direct method of control may also be applied to groups of actuator modules to increase output force, wherein cycling is achieved through cyclic control signals applied to the actuator modules.

Cyclic actuation may also be achieved passively through internal mechanical valves and flow paths in pneumatic modules. For example, a constant pressurized air source may be supplied to an actuator module, and the resulting motion is not a single power stroke but auto-reciprocation. As the motion of the piston affects the clutch mechanism by engaging and pulling on the driven member to produce overall actuator power, the motion also regulates and reverses the flow of the supply pressure to actively drive the piston in the return direction. Once reset, the flow path is automatically mechanically reversed, and the process repeats. This method can achieve output power from the expansion of air acting on the piston face alone, or can also gain additional momentary impulse force from the collision of the piston with a separated output stage connected to the clutch mechanism. In such an embodiment, the impact of the piston creates a hammering effect, which contributes to a larger force output of the actuator module.

### Example 7

This is an example of a combustion powered actuator unit based on combustion of a fuel (e.g., a chemical or gas in liquid of vapour phase) to generate pressure acting against a piston to create linear motion and force. A combustion powered actuator unit may be modularly attached to a driving member (e.g., a rod) which provides output force to interact with the environment. Multiple actuators may be mechanically connected together and activated simultaneously in asynchronous and/or synchronous configurations in order to adjust the speed and/or force of the rod as required. When the combustion powered actuator unit is not activated (i.e., there is no combustion) the actuator enters an idle state in which the rod can be freely driven by external force, by the attached load, etc.

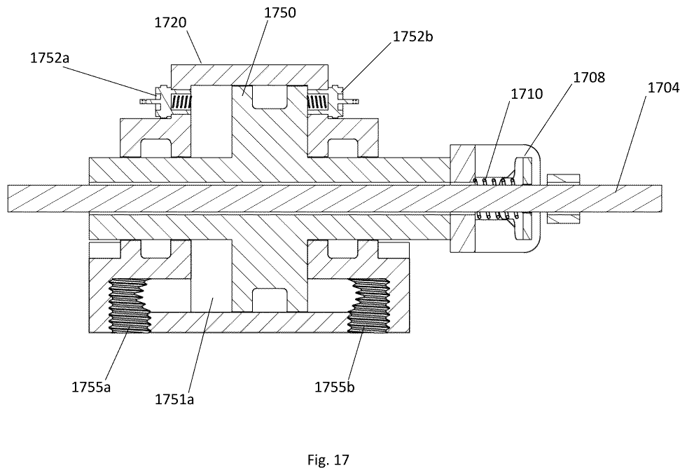

FIG. 17 is a diagram of a cross section through the actuator unit. Referring to FIG. 17, the actuator housing 1720 provides an axial internal combustion chamber. An axial piston 1750 is disposed in the combustion chamber. FIG. 17 shows the combustion chamber 1651a to the left of the piston 1750, when the piston is at the right limit of travel. Although not shown, it will be readily apparent that when the piston is at the left limit of travel the combustion chamber is to the right of the piston 1750. Ports 1755a and 1755b, which may include valves, gates, injectors, etc., which may be servo/electrically controlled or mechanically controlled through a linkage, are provided to facilitate the application of fuel to the combustion chamber and/or the removal of exhaust from the combustion chamber to the left and right of the piston, respectively. For example, there may be two ports on each side of the piston 1750 to facilitate delivery of fuel and removal of exhaust. The fuel may be ignited by an electrical discharge using spark plugs 1752a and 1752b, piezo electric devices, etc. in the left and right sides of the combustion chamber. The piston 1750 drives the driving rod 1704 via a clutch mechanism, which in this embodiment includes a wedge plate 1708 and spring 1710. Thus, upon combustion in the combustion chamber 1751a to the left of the piston, the piston 1750 is driven to the right, which causes the clutch 1708 to engage and exert a force on the driving rod 1704 to create the linear power. A requirement for the axial configuration where the piston 1750 is aligned with the driven member 1704 is that the combustion chamber must be properly sealed at the interface of the driven member while allowing the driven member to move through it. A suitable controller includes timing signals to control activation of the ports for delivery of fuel and removal of exhaust and to control the discharge of the spark plugs for proper reciprocal operation of the motor to achieve cyclic actuation. The controller may also implement a free-wheeling mode wherein at least some of the ports (e.g., the exhaust ports) are held open and there is no combustion so that the driving rod 1704 is freely back-drivable.

Whereas the embodiment described above and shown in FIG. 17 may be operated with a power stroke in both axial directions, it will be appreciated that some embodiments may implemented with only one spark plug 1752a and reduced number of ports for combustion and exhaust on only on side of the piston 1750 (e.g., the left side in FIG. 17), wherein a simple port to the right side of the piston may be operated as needed to reduce back pressure and allow free-wheeling operation.

### Example 8

This example describes alternative clutch mechanism embodiments.

In some embodiments the clutch mechanism may be implemented with one or more members having a cam shaped jaw profile that interacts with the driven member. The cam shape enhances the mechanical advantage of the power stroke since the gripping force increases with the range of motion of the jaws, as the cam shaped member(s) continues to close. A cam shape also enhances the ability of the mechanism to unlock and release the driven member on the return stroke. A clutch mechanism with cam shaped members may also be used with flexible driven members or cables.

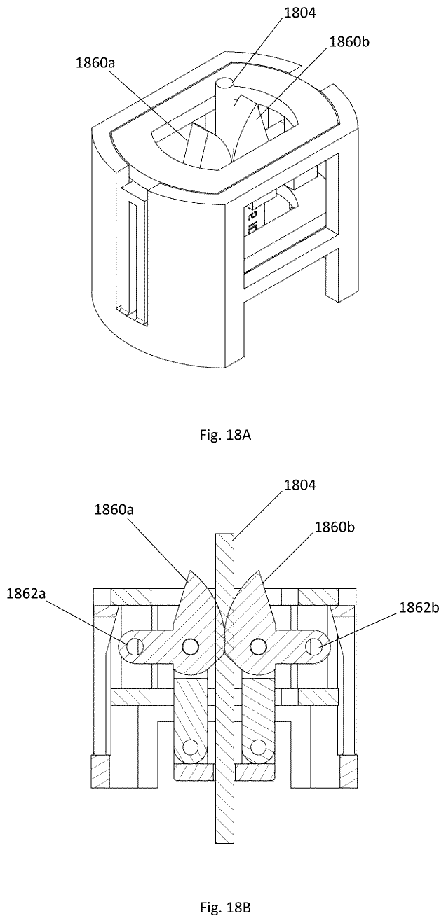

FIG. 18A is a diagram of a clutch mechanism with two cam shaped jaws, and FIG. 18B shows a cross section. The embodiment is shown in the closed position, wherein the cam shaped jaws 1860a, 1860b are closed against the driven member 1804 and can pivot about points 1862a, 1862b to open and close. Other numbers of jaws may be implemented. In some embodiments the surface of the jaws that contacts the driven member may be shaped (e.g., concave) and/or have a surface feature to enhance contact and grip with the driven member.

In some embodiments the clutch mechanism may be implemented with one or more jaws or fingers closely arranged around the driven member (rod or cable) in the neutral position. When activated, a clutch driver exerts a force on an arrangement of linkages which causes the one or more jaws or fingers to engage the driven member. The linkages operate a fixed mechanical sequence which involves first closing the jaws or fingers to engage the driven member. The power stroke of the actuator then pulls the clutch mechanism and subsequently the driven member with it. On the return or reset stroke of the actuator, the linkages acts in reverse, unlocking first and then allowing the clutch assembly to return to its neutral position. In this way, minimal or no force is exerted on the driven member in one direction on the reset stroke, while most of the actuator power is transmitted only in the driven direction of the power stroke. Embodiments according to this clutch mechanism do not require high precision alignment or rigidity of the driven member (as in the case of a wedge plate), and can accommodate flexible driven members such as a cable or flexible rod.

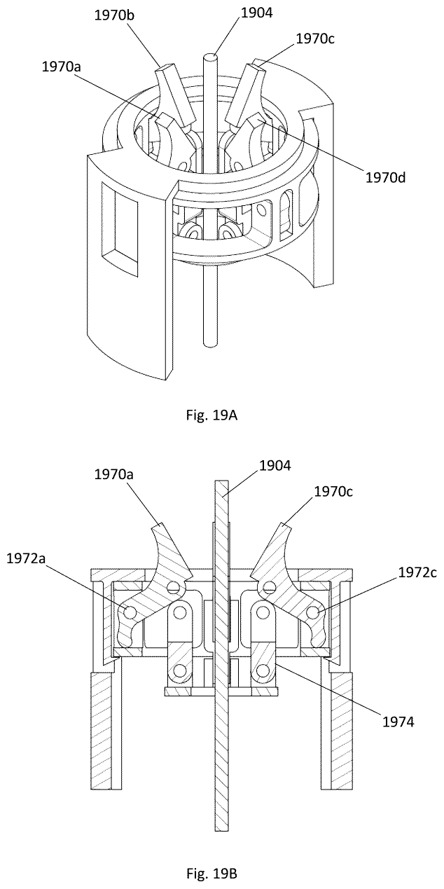

FIG. 19A is a diagram of a clutch mechanism with four fingers, and FIG. 19B shows a cross section. The embodiment is shown in the open (neutral) position, wherein the fingers 1970a-1970d are not engaging the driven member 1904. A linkage 1974 biases the fingers in the neutral position. During a power stroke of the actuator the linkage is moved downward (referring to FIGS. 19A and 19B), causing the fingers to rotate about their respective pivot points (e.g., 1972a and 1972c for fingers 1970a and 1970c) to engage the driven member. Other numbers of fingers may be implemented.

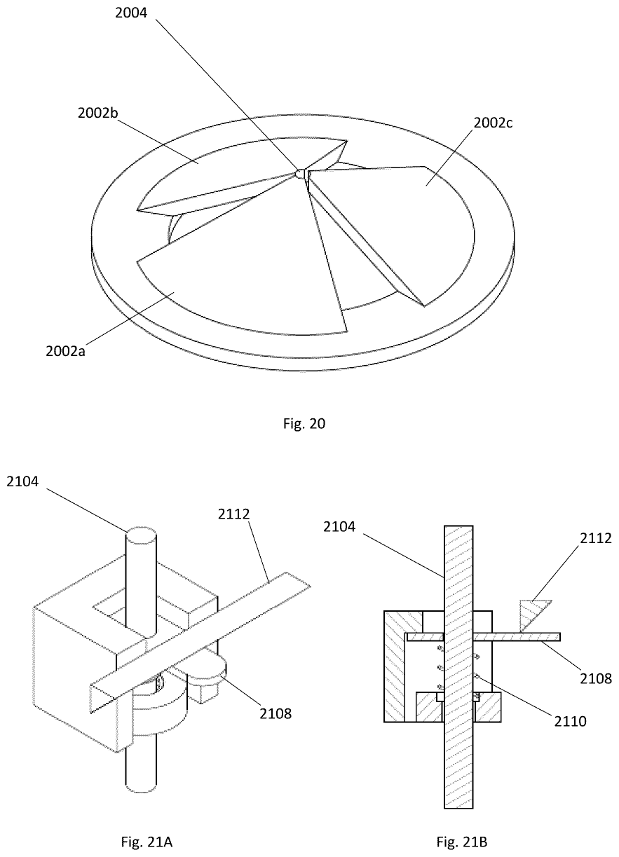

FIG. 20 is a diagram of a further embodiment of a clutch mechanism wherein three fingers 2002a, 2002b, 2002c are arranged about a central axis 2004. A driven member (not shown) passes through the central axis 2004, and the fingers can pivot upwards (referring to FIG. 20) to provide a neutral position and downwards to engage the driven member. This embodiment may optionally include a spring or other mechanism such as a linkage to bias the fingers toward the neutral position. Other numbers of fingers may be implemented.

FIG. 21A is a diagram of a wedge plate clutch mechanism, and FIG. 21B shows a cross section. In this embodiment the wedge plate 2108 is substantially perpendicular to the driven member 2104 in the neutral position (not engaged) and is maintained in this position with a spring 2110. A pushing bar 2112 is mechanically linked to the force generating element (not shown), and upon activation of the force generating member, pushes the wedge plate into the position where it is engaged with the driven member. Advantageously, this embodiment has less travel than the embodiment shown in e.g., FIG. 1, because the pushing bar has to first push down until the wedge plate is at an angle to engage the driven member and substantially the full power stroke of the driven member can occur. Also, in this embodiment the wedge plate is substantially not in constant contact with the driven member in the neutral position, which reduces friction in the return stroke of the clutch/driven member.

### Example 9

This is an example of an electrostatically driven fluidic powered actuator unit based on a liquid-amplified zipping mechanism (e.g., a hydraulically amplified self-healing electrostatic (HASEL)). A HASEL powered actuator unit may be modularly attached to a driving member (e.g., a rod) which provides output force to interact with the environment. Multiple actuators may be mechanically connected together and activated simultaneously in asynchronous and/or synchronous configurations in order to adjust the speed and/or force of the rod as required. When the actuator unit is not activated it enters an idle state in which the rod can be freely driven by external force, by the attached load, etc. A HASEL powered actuator may produce wide bandwidth actuation with fixed stroke length.

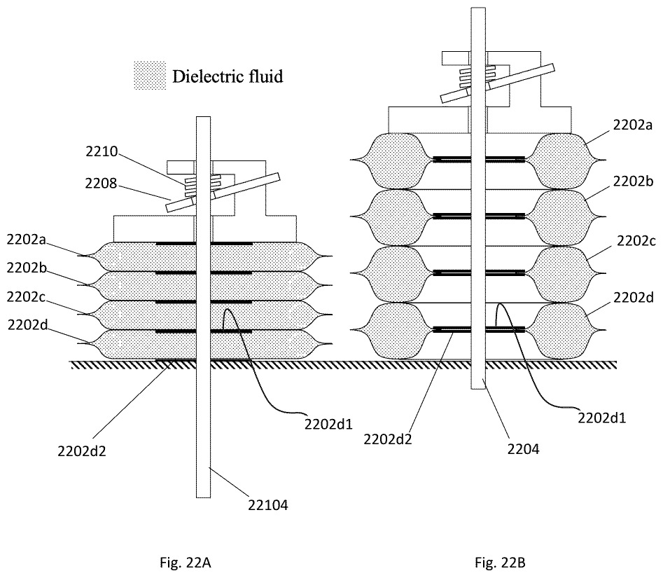

FIGS. 22A and 22B are diagrams showing cross sections of an embodiment in neutral and activated states, respectively. The actuator is assembled from a plurality of cells, of which four 2202a-2202d are shown in the figures. More or fewer cells may be used. Each cell is constructed with an inelastic flexible membrane filled with a dielectric fluid (e.g., a light oil), which is sealed in the cell in a substantially flat profile so that the cells are stackable. A flexible conductive material is disposed on the two opposing outer surfaces (top and bottom in the figures) of each cell. For simplicity, the flexible conductive material is indicated at 2202d1 and 2202d2 for cell 2202d in FIGS. 22A and 22B, but it will be apparent that all cells have the flexible conductive material. The flexible conductive materials of the two opposing surfaces are respectively connected to positive and negative polarity terminals of a power source. When electrostatic power is applied, the cell expands as a result of the two inner faces of the cell being drawn together by electrostatic forces (see FIG. 22A vs FIG. 22B). The expansion of the cells produces an actuating force, which can be amplified by stacking cells to achieve higher range of motion. The cells may have an opening (e.g., in the center) to accept a driven member 2204, and the stacked cells are aligned in their axial direction (i.e., the direction of expansion) to accept the driven member 2204 in sliding fit. A HASEL or other configuration of liquid zipping actuators may be used as a motor to power a clutch mechanism in an actuator module according to embodiments described herein, where the embodiment in FIGS. 22A and 22B include a clutch mechanism based on a wedge plate 2208 and spring 2210. Such an actuator module advantageously provides an extended stroke length relative to other embodiments based on, e.g. solenoids or voice coils, and also in enables increased power output using multiple actuator modules, as a result of the parallel and offset architecture for design and control of a combined multi-module actuator system.

### EQUIVALENTS

It will be appreciated that modifications may be made to the embodiments described herein without departing from the scope of the invention. Accordingly, the invention should not be limited by the specific embodiments set forth, but should be given the broadest interpretation consistent with the teachings of the description as a whole.

### REFERENCES

[1] L. Ge, S. Sethi, L. Ci, P. M. Ajayan, and A. Dhinojwala, “Carbon nanotube-based synthetic gecko tapes,” Proceedings of the National Academy of Sciences, vol. 104, pp. 10792-10795, June 2007.
[2] C. Stefanini, S. Orofino, L. Manfredi, S. Mintchev, S. Marrazza, T. Assaf, L. Capantini, E. Sinibaldi, S. Grillner, P. Wallen, and P. Dario,′ “A novel autonomous, bioinspired swimming robot developed by neuroscientists and bioengineers,” Bioinspiration & Biomimetics, vol. 7, p. 025001, June 2012.
[3] L. H. Blumenschein, M. M. Coad, D. A. Haggerty, A. M. Okamura, and E. W. Hawkes, “Design, Modeling, Control, and Application of Everting Vine Robots,” Frontiers in Robotics and AI, vol. 7, p. 548266, November 2020.
[4] H. Schulte, “The characteriristics of the Mckibben artificial muscle,” The Application of External Power in Prothetis and Orthotics, vol. 87, pp. 94-115, 1961.
[5] F. Daerden and D. Lefeber, “Pneumatic Artificial Muscles: actuators for robotics and automation,” European Journal of Mechanical and Environmental Engineering, vol. 47, March 2002.
[6] E. Ball and E. Garcia, “Effects of Bladder Geometry in Pneumatic Artificial Muscles,” Journal of Medical Devices, vol. 10, p. 041001, December 2016.
[7] H. S. Cho, T. H. Kim, T. H. Hong, and Y.-L. Park, “Ratchet-integrated pneumatic actuator (RIPA): a large-stroke soft linear actuator inspired by sarcomere muscle contraction,” Bioinspiration & Biomimetics, vol. 15, p. 036011, March 2020.
[8] E. Acome, S. K. Mitchell, T. G. Morrissey, M. B. Emmett, C. Benjamin, M. King, M. Radakovitz, and C. Keplinger, “Hydraulically amplified self-healing electrostatic actuators with muscle-like performance,” Science, vol. 359, pp. 61-65, January 2018.
[9] P. Rothemund, N. Kellaris, S. K. Mitchell, E. Acome, and C. Keplinger, “HASEL Artificial Muscles for a New Generation of Lifelike Robots—Recent Progress and Future Opportunities,” Advanced Materials, vol. 33, p. 2003375, May 2021.

1. An actuator, comprising:
a motor operable in first and second substantially opposite actuation directions;
a driving member that is driven by the motor during at least the first actuation direction;
a clutch that passively engages the driving member during the first actuation direction of the motor;
wherein a force generated by the motor in the first actuation direction maintains the clutch engaged with the driving member and the force is transferred to the driving member;
wherein the driving member is maintained in position against a back-driving force by the clutch when the motor is actuated in the first direction;
wherein the driving member is back-drivable when the clutch is disengaged.

2. The actuator of claim 1, wherein the clutch is disengaged when the motor is actuated in the second direction.

3. The actuator of claim 1, wherein the motor is electrically actuated.

4. The actuator of claim 3, wherein the motor comprises one or more of a voice coil, a solenoid, and a shape memory alloy.

5. The actuator of claim 1, wherein the motor is based on a pneumatic, hydraulic, combustion, or liquid-amplified zipping mechanism.

6. The actuator of claim 1, wherein the clutch includes a mechanism comprising a wedge plate, or at least one cam shaped jaw, or at least one finger.

7. The actuator of claim 1, wherein the actuator comprises a modular topology adapted for use in a recruitable actuator system comprising two or more said actuators.

8. An actuator system comprising:
two or more actuators according to claim 1; and
a controller.

9. The actuator system of claim 8, wherein the controller implements a control strategy that controls speed and/or power of the system by one or more of recruiting individual actuators, controlling actuation frequency of the actuators, and controlling timing of actuation of recruited actuators.

10. The actuator system of claim 9, wherein the controller implements the control strategy by applying substantially the same input electrical power to each actuator.

11. The actuator system of claim 8, wherein an actuator that is not recruited remains idle and the driving member of the actuator that is not recruited is substantially freely back-drivable by the system.

12. A method for implementing an actuator, comprising:
providing a motor operable in first and second substantially opposite actuation directions;
providing a driving member that is driven by the motor during at least the first actuation direction;
providing a clutch that passively engages the driving member during the first actuation direction of the motor;
wherein a force generated by the motor in the first actuation direction maintains the clutch engaged with the driving member and the force is transferred to the driving member;
wherein the driving member is maintained in position against a back-driving force by the clutch when the motor is actuated in the first direction;
wherein the driving member is back-drivable when the clutch is disengaged.

13. The method of claim 12, wherein the clutch is disengaged when the motor is actuated in the second direction.

14. The method of claim 12, wherein the motor is electrically actuated.

15. The method of claim 12, wherein the motor comprises one or more of a voice coil, a solenoid, and a shape memory alloy.

16. The method of claim 12, wherein the motor is based on a pneumatic, hydraulic, combustion, or liquid-amplified zipping mechanism.

17. The method of claim 12, wherein the clutch includes a mechanism comprising a wedge plate, at least one cam shaped jaw, or at least one finger.

18. The method of claim 12, wherein the actuator comprises a modular topology adapted for use in a recruitable actuator system comprising two or more said actuators.

19. The method of claim 18, comprising providing two or more actuators in an actuator system; and
using a controller to control actuation of the two or more actuators.

20. The method of claim 19, wherein the controller implements a control strategy that controls speed and/or power of the actuator system by one or more of recruiting individual actuators, controlling actuation frequency of the actuators, and controlling timing of actuation of recruited actuators.

21. The method of claim 20, wherein the controller implements the control strategy by applying substantially the same input electrical power to each actuator.

22. The method of claim 20, wherein an actuator that is not recruited remains idle and the driving member of the actuator that is not recruited is substantially freely backdrivable by the system.

23. A controller for an actuator system comprising two or more actuators, the controller comprising:
a processor;
non-transitory computer-readable storage media containing stored instructions executable by the processor, wherein the stored instructions direct the processor to perform calculations to generate output control signals to the two or more actuators;
wherein the control signals include signals that initiate priming and power strokes of the two or more actuators according to phase control including recruitment of the two or more actuators and/or a timing function to control timing of signals for the recruited two or more actuators;
wherein the controller implements a feedback loop wherein the actuator system output is sensed by one or more of a force sensor, position sensor, velocity sensor, accelerometer, and inertial measurement unit and one or more sensed values are compared to target value and a result of the comparison is used as input to the phase control to determine a number of actuators to be recruited from the two or more actuators, and the timing function determines the timing of the control signals to achieve the target values.

24. Non-transitory computer-readable storage media containing stored instructions executable by a processor, wherein the stored instructions direct the processor to perform calculations to generate output control signals to control two or more actuators in an actuator system;
wherein the control signals include signals that initiate priming and power strokes of the two or more actuators according to phase control including recruitment of the two or more actuators and/or a timing function to control timing of signals for the recruited two or more actuators;
wherein the controller implements a feedback loop wherein the actuator system output is sensed by one or more of a force sensor, position sensor, velocity sensor, accelerometer, and inertial measurement unit and one or more sensed values are compared to target value and a result of the comparison is used as input to the phase control to determine a number of actuators to be recruited from the two or more actuators, and the timing function determines the timing of the control signals to achieve the target values.
